(19) United States
(12) Patent Application Publication
(10) Pub. No.: US 2018/0329664 A1
(43) Pub. Date: Nov. 15, 2018

(54) Methods, systems, and computer readable media for controlling virtual image scenarios in plurality display devices

(71) Applicants: YA-JU CHANG, TAIPEI (TW); HUNG-BIN CHEN, TAIPEI (TW)

(72) Inventors: YA-JU CHANG, TAIPEI (TW); HUNG-BIN CHEN, TAIPEI (TW)

(21) Appl. No.: 15/679,224

(22) Filed: Aug. 17, 2017

(30) Foreign Application Priority Data
Aug. 10, 2016 (TW) 105125396

(51) Int. Cl. G06F 3/147; G06F 3/033; G06F 3/01

(52) U.S. Cl. CPC G06F 3/147; G06F 3/012; G06F 3/033

(57) ABSTRACT

Methods, apparatuses, and computer readable media for controlling virtual image scenarios in plurality display devices are disclosed. The method comprising: establishing, by a first display device in the virtual image system, a first virtual image scenario according to at least one predetermined image; receiving, by the first display device, a control signal; calculating, by the first display device, an absolute coordinate value corresponding to the at least one predetermined image according to an orientation and a view field of the first display device and the control signal; and displaying, by the first display device, a first object in the first virtual image scenario according to the absolute coordinate value.

### CROSS REFERENCE

This application claims priority to Taiwan Patent Application No. 105125396 filed on Aug. 10, 2016, which is hereby incorporated by reference in its entirety.

### BACKGROUND OF THE INVENTION

### 1. Field of the Invention

The subject matter described herein relates to virtual image scenarios. More particularly, the subject matter described herein relates to methods, systems, and computer readable media for controlling virtual image scenarios in plurality display devices.

### 2. Description of Related Art

With the prevalence of applications in a virtual image (VI) which can be applied to virtual reality (VR), or Augmented Reality (AR), or Mixed Reality (MR), or Substitutional Reality (SR), or Cinematic Reality (CR), products of headset design (e.g., VR Box, Cardboard), in which smartphones and tablets could be placed inside to form “Smartphone Headset Displaying Device”, related applications of virtual reality will come into work. However, as smartphones and tablets are placed inside VR Box or Cardboard and mounted on the head for the application of VR (or AR, or MR, or SR, or CR), the function of touch screen or the keyboard (or button) in the smartphone (or tablet) operation will be made impossible. A conventional resolution is to display at least one menu(s) including various lists of options and at least one virtual key(s) (or button(s)) in the center of the VI screen and with the up, down, left, and right movements of the head to move the VI screen around to choose from the list of the application program and a longer stay of the key on certain option to confirm the selection. Although a conventional input device with wireless transmission to produce a relative coordinate of the screen of the display device (e.g., smartphone, or tablet) to control the screen cursor of the display device is used, a virtual reality under divided display of the same virtual image viewed under a sphere causes the screen cursor which is based on the display device's screen coordinates cannot be operated under the virtual image (i.e. the virtual image is not corresponding to the original location of the display device's screen. That is to say, the absolute coordinate system of the virtual image is independent on the coordinate system of the display device's screen).

In addition, under the other application, navigation, orientation, presentation, practice, briefing, and teaching can be done through virtual reality technique. Explanation is accomplished through labeling and highlighting. In other words, spectators and listeners must see and find these in the virtual reality environment and any labels operated in the presentation.

### SUMMARY OF THE INVENTION

In consideration of the problems of the prior art, one of objects of the present invention is to provide methods, systems, and computer readable media for controlling virtual image scenarios (e.g., VR, or AR, or MR, or SR, or CR scenario) to improve the prior art.

One of the objects of the present invention is to provide methods, systems, and computer readable media to accomplish operation of pointing control under virtual image scenarios.

One of the objects of the present invention is to provide methods, systems, and computer readable media to let other users know the operation of the primary user under virtual image (e.g., VR, or AR, or MR, or SR, or CR) scenarios.

The present disclosure discloses a method for controlling a virtual image system, the method comprising: establishing, by a first display device in the virtual image system, a first virtual image scenario according to at least one predetermined image; receiving, by the first display device, a control signal; calculating, by the first display device, an absolute coordinate value corresponding to the at least one predetermined image according to an orientation and a view field of the first display device and the control signal; and displaying, by the first display device, a first object in the first virtual image scenario according to the absolute coordinate value.

The present invention also discloses a virtual image system, the virtual image system comprising: a first display device comprising a first display unit, a first transceiver, and a first processor, an operation mode of the first display device comprising a virtual image (VI) mode; wherein when the first display device operates at the VI mode, the first display device is configured to establish a first virtual image scenario according to at least one predetermined image, to receive a control signal comprises at least one of a movement amount and a command, to calculate an absolute coordinate value corresponding to the at least one predetermined image according to an orientation and a view field of the first display device and the control signal; and to display a first object in the first virtual image scenario according to the absolute coordinate value.

The present invention also discloses a computer-readable memory comprising a set of instructions stored therein which, when executed by a processor, causes the processor to perform steps comprising: establishing a first virtual image scenario according to at least one predetermined image; receiving a control signal; calculating an absolute coordinate value corresponding to the at least one predetermined image according to an orientation and a view field of the first display device and the control signal; and displaying a first object in the first virtual image scenario according to the absolute coordinate value.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

Embodiments of the disclosure will now be described with reference to the attached drawings wherein:

FIG. 1 illustrates a block diagram of the virtual image (VI) control broadcasting system 100 for performing guiding orientation or presentation in the VI scenario according to an embodiment of the present invention.

FIG. 2 illustrates a detailed block diagram of the VI control broadcasting system 100 in FIG. 1.

FIG. 3A illustrates a flow chart of a first embodiment of the operation between the first VI display device 120 and the VI control device 130 in the VI control system 110 according to an embodiment of the present invention.

FIG. 3B illustrates a flow chart of a second embodiment of the operation between the first VI display device 120 and the VI control device 130 of the VR control system 110 according to one embodiment of the present invention.

FIG. 4 illustrates a flow chart of embodiment of cursor display of the second VI display device 160) according to the present invention.

FIG. 5 illustrates a flow chart of an embodiment of an established VI scenario in the first VI display device 120 (or the second VR display device 160) according to the present invention.

FIG. 6A-6D illustrates the corresponding display from first VI display device 120 and the second VI display device 160 according to the operation of the control device 130 according to another embodiment of the present invention.

### DETAILED DESCRIPTION OF THE PREFERRED EMBODIMENTS

The following description is written by referring to terms acknowledged in this invention filed. If any term is defined in the specification, such term should be explained accordingly. Besides, the connection between objects or events in the disclosed embodiments can be direct or indirect provided that these embodiments are still applicable under such connection. Said “indirect” means that an intermediate object or a physical space is existed between the objects, or an intermediate event or a time interval is existed between the events. In addition, the following description relates to image processing, and the background knowledge thereof will be omitted here if such background knowledge has little to do with the features of the present invention. Furthermore, the shape, size, and ratio of any element and the step sequence of any flow chart in the disclosed figures are just exemplary for understanding, not for limiting the scope of this invention.

Each embodiment in the following description includes one or more features; however, this doesn't mean that one carrying out the present invention should make use of all the features of one embodiment at the same time, or should only carry out different embodiments separately. In other words, if an implementation derived from one or more of the embodiments is applicable, a person of ordinary skill in the art can selectively make use of some or all of the features in one embodiment or selectively make use of the combination of some or all features in several embodiments to have the implementation come true, so as to increase the flexibility of carrying out the present invention.

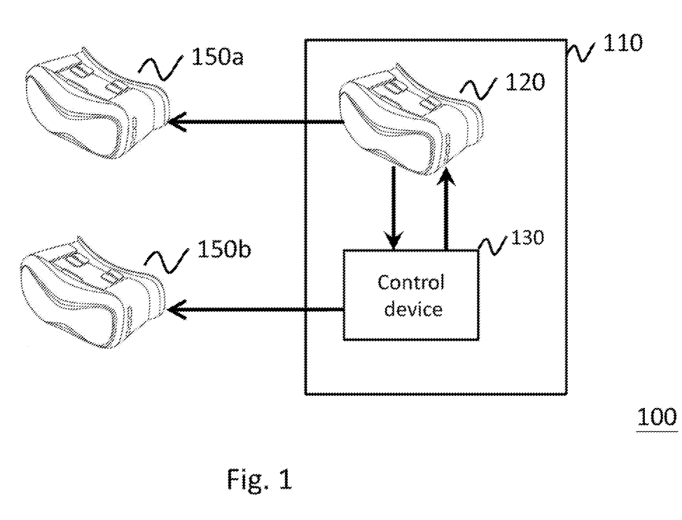

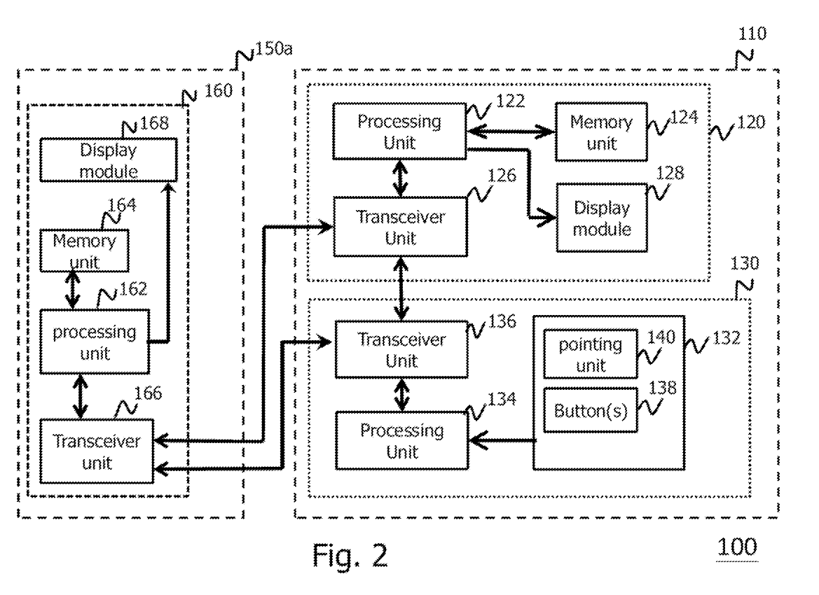

FIG. 1 illustrates a block diagram of the virtual image (VI) control broadcasting system 100 according to an embodiment of the present invention for performing guiding orientation or presentation in the virtual image (VI) (e.g., VR, or AR, or MR, or SR, or CR) scenario. FIG. 2 illustrates a detailed block diagram of the VI control broadcasting system 100 in FIG. 1. Referring to FIG. 1 and FIG. 2, the VI control broadcasting system 100 comprises a VI control system 110 and at least one VI display systems 150a and 150b. The VI control system 110 includes a first VI displaying device 120 and a VI control device 130. The first VI displaying device 120 and at least one VI display systems 150a and 150b are headset displaying devices. The VI display devices 150a and 150b contain a second VI displaying device 160 and a headset device (e.g., VR Box or Google Cardboard). In an embodiment, the VI displaying device 120 (160) includes a smartphone (or tablet) and the headset device. As the smartphone (or tablet) is placed inside the headset device, it becomes a headset displaying device. In that, the first VI displaying device 120 includes a processing unit 122, a memory unit 124, a transceiver unit 126 and a display module 128. An application program is stored in the memory unit 124 which functions according to the predetermined steps of this present disclosure. The second VI displaying device 160 includes a processing unit 162, a memory unit 164, a transceiver unit 166 and a display module 168. An application program is stored in the memory unit 164 which functions according to the predetermined steps of this present disclosure.

In an embodiment, the presenter wears the first VI displaying device 120 on the head to make presentation. The listeners wear the VI display system 150a on their heads. The cursor can be manipulated on the screen as the first VI display device 120 display a VI scenario under the operation of VI control device 130 by the presenter. At the same time, the first display device 120 (or the control device 130) of the VI control system 110 produces an absolute coordinate value corresponding to a predetermined texture (e.g., 360° panoramic image) according to the cursor manipulated by the presenter in the VI scenario. The absolute coordinate value of the predetermined texture is broadcasted to the VI display systems 150a, 150b. The second VI display device 160 of the VI display system 150a, 150b display a corresponding cursor in its VI scenario according to the absolute coordinate value from the VI control system 110. As the absolute coordinate value of the predetermined texture is independent on the screen of VI display devices 120, 160, the first VI display device 120 and the second VI display device 160 will display a corresponding marker (e.g., cursor) according to the coordinate value of the predetermined texture even if their orientation or/and field of view are in difference. In a preferred embodiment, the VI control system 110 and the at least one VI display system 150a communicate wirelessly via Bluetooth (or Wi-Fi or RF) as the communication protocol. The VI control system 110 broadcasts the coordinate value corresponding to the predetermined texture to the at least one VI display device 150.

Further, the communication between the VI control device 130 and the first VI display device (smartphone) 120 may be wired or wireless. In a preferred embodiment, the communication between the VI control device 130 and the first VI display device (smartphone) 120 uses Bluetooth or Wi-Fi or RF protocol.

Refer again to FIG. 2. The VI control device 130 in FIG. 2 comprises a pointing module 132, a process unit 134 and a transceiver unit 136. In an embodiment, the pointing module 132 comprises at least one button(s) 138 and a pointing unit 140. In that, the button(s) 138 is used to enter a corresponding operation, such as switching predetermined texture, display or hidden cursor, play film control, etc. control commands. The pointing unit 140 is used to control the up-down and left-right movements of the cursor. The process unit 134 receives an output from the pointing module 132 and sends a control signal to the first VI display device 120 via the transceiver unit 136. The control signal includes information corresponding to output from at least one button(s) 138 and a pointing unit 140. In an embodiment, a transceiver unit 126, 136, and 166 are wireless (e.g., Bluetooth or Wi-Fi or RF) transceivers.

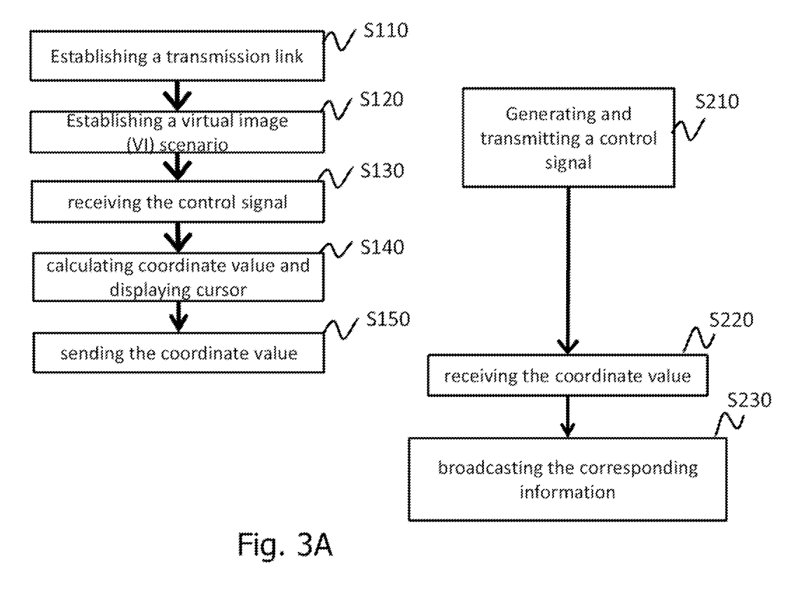

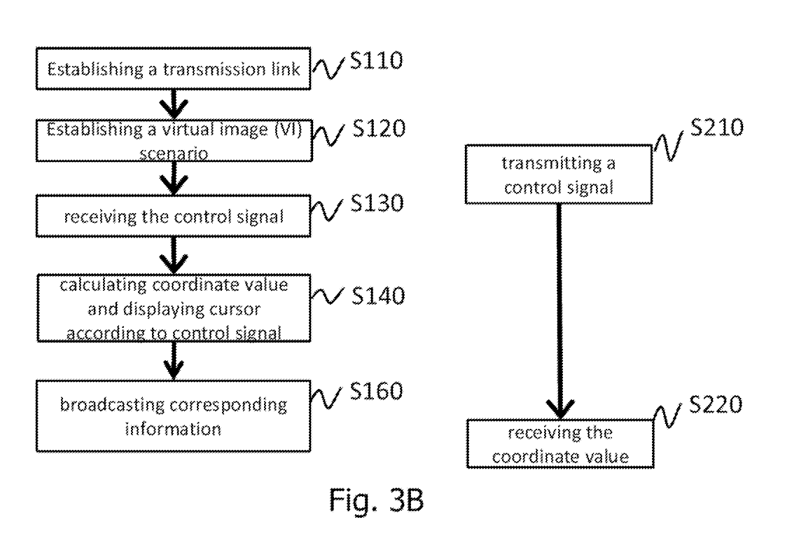

Please refer to FIG. 2 and FIG. 3A. FIG. 3A illustrates a flow chart of a first embodiment of the operation between the first VI display device 120 and the VI control device 130 in the VI control system 110 according to the present invention. Steps S110˜S150 are the operation of the first VI display device 120 according to the program (e.g., a set of instructions) stored in memory unit 124 embedded in the first VI display device 120. The memory 124 comprises a set of instructions stored therein which, when executed by the processor 122, causes the processor 122 of the VI display device 120 to perform steps S110˜S150. Steps S210˜S230 are the operation of the VI control device 130 in FIG. 2 according to a program (e.g., a set of instructions) stored in the VI control device 130. The detail description of Steps S110˜S150 are as follows:

S110: As worn by the presenter on the head, the first VI display device 120 establishes a transmission link with the VI control device 130 through wireless (e.g. Bluetooth) or wire (USB) communication.

S120: The first VI display device 120 establishes a virtual image (VI) scenario according to a predetermined image(s) (e.g., at least one image(s), or film, or PowerPoint file, or Video file) from a memory unit 124 or an external source communicated with the first VI display device 120. In an embodiment, the command of establishing VI scenario is from the operation of the VI control device 130. The reception of command from the VI control device 130 comes after the transmission link is established (S110). In the other embodiment, the command of establishing VI scenario is operated by the presenter directly to the first VI display device 120. In this way, there will be no sequential relation between S110 and S120 temporally. In Step S120, the first VI display device 120 will establish a virtual image scenario according to a predetermined image(s). In an embodiment, the first VI display device 120 converts the predetermined image(s) (e.g., 360° panoramic image) into a spherical texture and divides displays of the virtual image viewed under a sphere. The virtual image will be displayed on the left and right sub-windows correspondingly according to the orientation and view of field of the first VI display device 120. In other words, in S120, the VI scenario is formed by the first VI display device 120.

S130: The first VI display device 120 receives the control signal from the VI control device 130. The control signal is generated in Step S210. In an embodiment, the control signal includes movement information and an operation command(s). The movement information is generated according to the operation of the pointing unit 140 of the pointing module 132, and the operation information is generated according to the operation of the at least one button(s) 138 of the pointing module 132.

In Step S130, the first VI display device 120 obtains the change in the coordinate value according to a movement information (e.g., the amount of movement in the X-Y coordinate) of the control signal to execute corresponding curser movement, and obtains the corresponding operation command(s) according the an operation information, such as switch of the cursor texture, display hidden cursor, film broadcasting control and click on the program object, of the control signal.

S140: The first VI display device 120 displays a cursor in the virtual image (e.g., spherical image) according to the movement information of the control signal. The displayed location of the cursor in the virtual image corresponds to the operation of the pointing unit of the pointing module 132 in the VI control device 130. The first VI display device 120 obtains the absolute coordinate value of the displayed cursor with respect to the predetermined image (e.g., 360° panoramic image). The first VI display device 120 obtains the absolute coordinate value according to the data of an orientation and a field of view of the first VI display device 120 and the displayed location of the cursor in the first VI display device 120. The absolute coordinate value corresponds to the predetermined image(s) and is independent on the screen of the first VI display device 120.

S150: The first VI display device 120 sends the absolute coordinate value to the VI control device 130. The VI control device 130, in turn, broadcasts the corresponding information (such as, the absolute coordinate value, information of each on-off switch) to the second VI display device 160 of the other listeners.

Refer to FIG. 1 and FIG. 3A. S210˜230 are the operational steps of VI control device 130. Specification of the process is as follows:

S210: The process unit 134 of the control device 130 converses the operation of the pointing module 132 by the presenter to generate the control signal including the movement information and the corresponding command, and the control signal is transmitted to the first VI display device 120 through transmission circuit 136.

S220: The process unit 134 of the VI control device 130 receives the cursor coordinate value of the first VI display device 120 via the transmission circuit 136.

S230: The VI control device 130 broadcasts the corresponding information (such as the cursor coordinate value, on-off switch etc.) to the second VI display device 160 of all the other listeners such that the second VI display device 160 detects changes (operations) of the first VI display device 120.

FIG. 1 and FIG. 3B. FIG. 3B illustrates a flow chart of a second embodiment of the operation between the first VI display device 120 and the VI control device 130 of the VI control system 110 according to the present invention. The memory 124 comprises a set of instructions stored therein which, when executed by the processor 122, causes the processor 122 of the VI display device 120 to perform steps S110˜S160. Since Steps S110˜S140 in FIG. 3B is similar to the FIG. 3A, its explanation is omitted, only Step S160 will be specified as follows:

S160: The first VI display device 120 directly broadcasts the corresponding information (such as the absolute coordinate value, corresponding command(s) etc.) to the second VI display device 160 of all the other listeners.

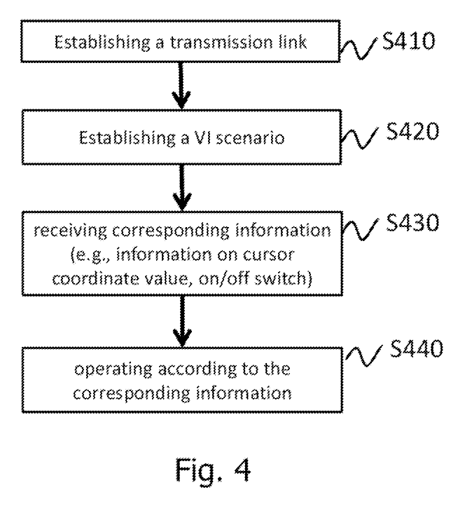

Refer to FIG. 1 and FIG. 4. FIG. 4 illustrates a flow chart of an embodiment of cursor display of the second VI display device 160 according to the present invention. Steps S410˜S440 are the steps of displaying a cursor of the second VI display device 160 according to the program (e.g., a set of instructions) stored in the memory unit 164. The memory 164 comprises a set of instructions stored therein which, when executed by the processor 162, causes the processor 162 of the second VI display device 160 to perform steps S410˜S440. Steps of S410˜S440 are as follows:

S410: The second VI display device 160 establishes a transmission link (e.g., Bluetooth) with the VI control system 110 (i.e., the first VI display device 120 or the pointing device 130).

S420: The second VI display device 160 establishes an interactive VI scenario according to the predetermined image(s).

S430: The second VI display device 160 obtains corresponding information (including the absolute coordinate value, corresponding command(s)) from the VI control system 110 via the transmission link.

S440: The second VI display device 160 operates to achieve the same operational execution as the first VI display device 120 according to the corresponding information. It also displays a cursor according to the absolute coordinate value.

Even if the first VI display device 120 and the second VI display device 160 differ in orientation and/or the field of view resulting in the difference in the visual sphere image for the presenter and the listeners, the cursor (mark) display by the first VI display device 120 and the second VI display device 160 will be at the same location of the predetermined image(s).

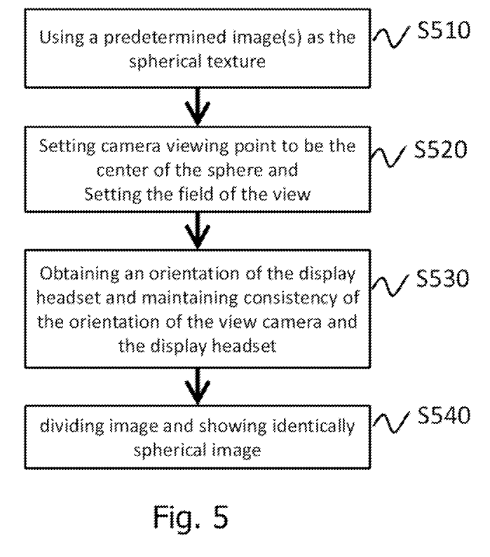

FIG. 5 illustrates a flow chart of an embodiment of an established VI scenario in the first VI display device 120 (Step S120) or the second VR display device 160 (Step S420) according to the present invention. Steps of S510˜S540 are as follows:

S510: Establishing a spherical texture according to the predetermined image(s) (such as 360° panorama image, film, briefing, PowerPoint file).

S520: Setting a viewing camera to be placed in a center of the sphere texture and setting a field of view of the viewing camera.

S530: Obtaining an orientation of the headset display device from the sensor (such as built-in accelerometer, gyro or magnetometer) in the VI display device 120 or 160 (smartphone, tablet), and maintaining the orientation of the view camera in consistent with the orientation of the headset display device

S540: Dividing display of the same image viewed under a sphere in the first display device 120 (or the second display device 160).

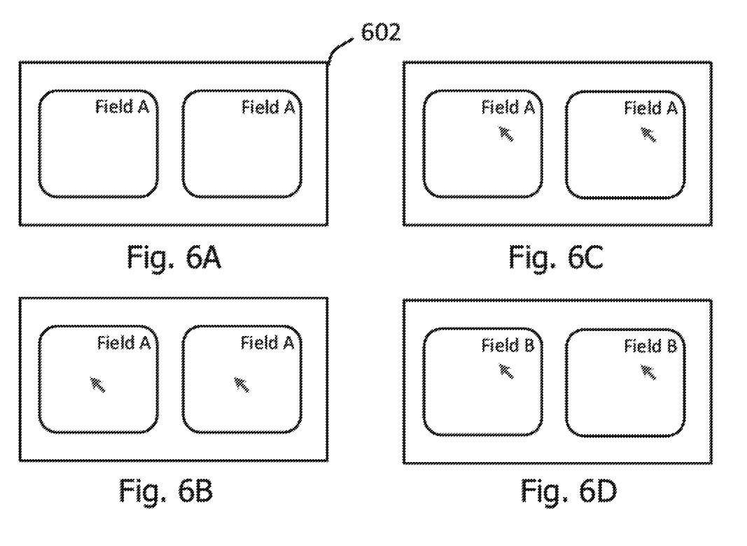

FIGS. 6A˜6D refer to corresponding display of the first display device 120 and the second display device 160 according to the control device 130. FIG. 6A reveals the first (second) display device 120 (160) displaying a virtual image scenario A. FIG. 6A shows a divided display of the same image viewed under a sphere (VI scenario A) on the screen 602 of the display device 120 (160). FIG. 6B shows the operation according to the button(s) 138 of the pointing module 132, in which the cursor is shown on the divided display of the VI image of screen 602 of the display device 120 (160). FIG. 6C reveals the operation to move the cursor according to the pointing unit 140 of the pointing module 132. FIG. 6D reveals switching of the VI scenarios (scene A to scene B) according to another button of the pointing module 132. Those who are familiar to the technique could make changes and editions according to their various needs and this disclosure.

In an embodiment, the program installed in the first display device 120 and the second display device 160 can be the same application program. In other words, the application program has a briefing mode and a listeners' mode. As the application is started, it will determine which mode to apply to the presenter and the listeners according to the user's settings.

A preferred embodiment, the control device 130 comprises at least two operational modes. For example, a non-VI mode and a VI mode. The control device 130 is preset as the non-VI mode. As such, under the non-VI mode, the control device 130 will disable the execution of S220 and S230 in FIG. 3A or disable the execution of S220 in FIG. 3B. Under the VI mode, the control device 130 enables S220 and S230 in FIG. 3A or S220 in FIG. 3B. As the transmission link among the smartphone (tablet) and the control device 130 is established, and the smartphone (tablet) not operating related VI application program, the control device 130 is used as the conventional control device for the smartphone, or tablet, or the first display device 120. When the control device 130 receives a mode control signal generated from a mode button of itself or the device connected to itself (e.g., the first display device 120), it means that the device has entered the VI mode, and the control device 130 will automatically switch to operate the VI mode. In another embodiment, the control device 130 can communicate with the first display device 120 via the transmission unit 136 and 126, and the control device 130 can be configured to detect (or be informed) that the first display device 120 operates in the VI mode (or establishes the VI scenario). The control device 130 will automatically switch to operate the VI mode.

In an embodiment, the control signal can be generated by a gesture identification function performed on the first display device 120, so that the control device 130 can be optional.

In a preferred embodiment, this display device 120 (160) can install a corresponding application comprising a plurality of instructions stored in the memory 124 (164) such that the display device 120 (160) can operate in at least two operational modes. For example, a non-VI mode and a VI mode. The display device 120 (160) is preset as the non-VI mode. When the display device 120 (160) operates in the non-VI mode, the display device 120 (160) receives the control signal from the control device 130, calculates a relative coordinate value of the screen of the display device 120 (160), and plays the cursor according to the relative coordinate value. When the display device 120 (160) operates in the VI mode, the display device 120 (160) receives the control signal from the control device 130, calculates an absolute coordinate value of the predetermined image(s), and plays the cursor according to the absolute coordinate value. In an embodiment, the display device 120 (160) switches to operates in the VI mode or the non-VI mode according to a switch signal of the control signal from the control device 130.

Please note that there is no step sequence limitation for the method inventions as long as the execution of each step is applicable. Furthermore, the shape, size, and ratio of any element and the step sequence of any flow chart in the disclosed figures are just exemplary for understanding, not for limiting the scope of this invention. Besides, each aforementioned embodiment may include one or more features; however, this doesn't mean that one carrying out the present invention should make use of all the features of one embodiment at the same time, or should only carry out different embodiments separately. In other words, if an implementation derived from one or more of the embodiments is applicable, a person of ordinary skill in the art can selectively make use of some or all of the features in one embodiment or selectively make use of the combination of some or all features in several embodiments to have the implementation come true, so as to increase the flexibility of carrying out the present invention.

The aforementioned descriptions represent merely the preferred embodiments of the present invention, without any intention to limit the scope of the present invention thereto. Various equivalent changes, alterations, or modifications based on the claims of present invention are all consequently viewed as being embraced by the scope of the present invention.

What is claimed is:

1. A method for controlling a virtual image system, the method comprising:
establishing, by a first display device in the virtual image system, a first virtual image scenario according to at least one predetermined image;
receiving, by the first display device, a control signal;
calculating, by the first display device, an absolute coordinate value corresponding to the at least one predetermined image according to an orientation and a view field of the first display device and the control signal; and
displaying, by the first display device, a first object in the first virtual image scenario according to the absolute coordinate value.

2. The method of claim 1, wherein the absolute coordinate value is independent on a screen of the first display device.

3. The method of claim 1, wherein the at least one predetermined image comprises a 360° panoramic image.

4. The method of claim 1, wherein the absolute coordinate value corresponds to a positioning information of the first virtual image scenario.

5. The method of claim 1, wherein the first display device broadcasts an information comprising the absolute coordinate value to a second display device in the virtual image system.

6. The method of claim 5, wherein the information further comprises a corresponding command of the first display device.

7. The method of claim 1, further comprising:
establishing, by the second display device, a second virtual image scenario according to the at least one predetermined image;
receiving, by the second display device, information comprising the absolute coordinate value; and
displaying, by the second display device, a second object in the second virtual image scenario according to the absolute coordinate value of the information,
wherein the first object and the second object are substantially at the same location of the at least one predetermined image.

8. The method of claim 7, wherein the first display device operates at a briefing mode and the second display device operates at a listeners' mode.

9. The method of claim 1, wherein the control signal is generated by a gesture performed on the first display device.

10. The method of claim 1, wherein the first display device operates at a virtual image (VI) mode or a non-VI mode according a mode control signal.

11. A virtual image system, the virtual image system comprising:
a first display device comprising a first display unit, a first transceiver, and a first processor, an operation mode of the first display device comprising a virtual image (VI) mode;
wherein when the first display device operates at the VI mode, the first display device is configured to establish a first virtual image scenario according to at least one predetermined image, to receive a control signal comprises at least one of a movement amount and a command, to calculate an absolute coordinate value corresponding to the at least one predetermined image according to an orientation and a view field of the first display device and the control signal; and to display a first object in the first virtual image scenario according to the absolute coordinate value.

12. The virtual image system of claim 11, wherein the first virtual image scenario is one of Virtual reality (VR), Augmented Reality (AR), Mixed Reality (MR), Substitutional Reality (SR), and Cinematic Reality (CR) scenarios.

13. The virtual image system of claim 11, further comprising:
a second display device comprising a second display unit, a second transceiver, and a second processor; an operation mode of the second display device comprising the virtual image (VI) mode;
wherein when the second display device operates at the VI mode, the second display device is configured to establish a second virtual image scenario according to the at least one predetermined image; to receive the absolute coordinate value produced from the first display device; and to display a second object in the second virtual image scenario according to the absolute coordinate value; and
wherein the first object and the second object are substantially at the same location of the at least one predetermined image.

14. The virtual image system of claim 11, wherein the operation mode of the first display device further comprises a non-VI mode;
wherein when the first display device operates at the non-VI mode, the first display device is configured to calculate a relative coordinate value of the screen of the first display device according to the control signal, and to display a third object according to the relative coordinate value.

15. The virtual image system of claim 11, wherein the control signal is generated by a control device comprising:
a pointing module comprising at least one button and a pointing unit;
a control circuit, coupled to the pointing module, to generate the control signal according to output of the pointing module; and
a transmission unit, coupled to the control circuit, to transmit the control signal to the first display device.

16. The virtual image system of claim 15, wherein the first display device operates at the VI mode or a non-VI mode according to a mode switch signal of the control signal from the control device.

17. A computer-readable memory comprising a set of instructions stored therein which, when executed by a processor, causes the processor to perform steps comprising:
establishing a first virtual image scenario according to at least one predetermined image;
receiving a control signal;
calculating an absolute coordinate value corresponding to the at least one predetermined image according to an orientation and a view field of the first display device and the control signal; and
displaying a first object in the first virtual image scenario according to the absolute coordinate value.

18. The computer-readable memory of claim 17, the set of instructions further comprising:
broadcasting an information comprising the absolute coordinate value.
